(19) United States
(12) Patent Application Publication
(10) Pub. No.: US 2026/0070446 A1
(43) Pub. Date: Mar. 12, 2026

(54) MOBILE POWER CONVERSION DEVICE FOR ELECTRIC VEHICLE CHARGING AND CONTROL METHOD THEREOF

(71) Applicants: Hyundai Motor Company, Seoul (KR); Kia Corporation, Seoul (KR)

(72) Inventors: Jin Su Jang, Hwaseong-si (KR); Yeongju Kang, Hwaseong-si (KR); Jong Yoon Chae, Hwaseong-si (KR); Sunghun Kim, Hwaseong-si (KR)

(21) Appl. No.: 19/323,462

(22) Filed: Sep. 9, 2025

(30) Foreign Application Priority Data
Sep. 10, 2024 (KR) 10-2024-0122960

(51) Int. Cl. B60L 53/31; B60L 53/16; B60L 53/30; B60L 53/62; B60L 53/66

(52) U.S. Cl. CPC B60L 53/31; B60L 53/16; B60L 53/305; B60L 53/62; B60L 53/66; B60L 2210/30

(57) ABSTRACT

A mobile power conversion device for electric vehicle charging and a control method thereof are disclosed. An embodiment of the present disclosure provides a mobile power conversion device for electric vehicle charging, including: a first charging interface electrically connected to an external AC charger on one side; a second charging interface electrically connected to a vehicle without an external on-board charger (OBC) on the other side; a power supply such as a switching mode power supply (SMPS) configured to supply power to the inside of the device; an AC/DC converter configured to convert AC power input from the AC charger into DC power chargeable to a high-voltage battery of the vehicle; and a controller configured to perform vehicle charging control supplying the DC power converted by the AC/DC converter to the vehicle.

### CROSS-REFERENCE TO RELATED APPLICATIONS

This application claims priority to and the benefit of Korean Patent Application No. 10-2024-0122960 filed in the Korean Intellectual Property Office on Sep. 10, 2024, the entire contents of which are incorporated herein by reference.

### TECHNICAL FIELD

The present disclosure relates to a mobile power conversion device for electric vehicle charging and a control method thereof, and more particularly, to a mobile power conversion device for electric vehicle charging and a control method thereof that supports electric vehicle AC charging from an external charging infrastructure.

### BACKGROUND

Typically, electric vehicles (including EVs and PHEVs) may charge their internal high-voltage batteries by connecting a charging cable from an external charging infrastructure, such as electric vehicle supply equipment (EVSE).

For example, FIG. 5 illustrates a conventional AC slow charging system for electric vehicle charging.

Referring to FIG. 5, conventional alternating current (AC) EVSEs in homes and/or public facilities may only supply AC power to electric vehicles. For this reason, conventional electric vehicles are required to be equipped with an on-board charger (OBC) that can convert input alternating current (AC) power into direct current (DC) output power. That is, the OBC equipped in an electric vehicle converts AC power supplied from an external AC slow charger into DC power and then slowly charges the high-voltage battery. Therefore, conventional electric vehicles can only use AC slow chargers when equipped with an OBC.

However, the OBC is an expensive component, and installing it in an electric vehicle has the problem of causing a decrease in electric mileage (driving distance) due to an increase in the weight of the vehicle and an increase in the vehicle price (manufacturing cost).

Conversely, if the OBC is not installed (omitted) in the electric vehicle, users face the inconvenience of constantly having to seek DC fast charging infrastructure due to the inability to charge using an AC slow charger, which leads to user dissatisfaction.

The above information disclosed in this Background section is only for enhancement of understanding of the background of the invention, and therefore it may contain information that does not form the prior art that is already known in this country to a person of ordinary skill in the art.

### SUMMARY

An embodiment of the present disclosure aims to provide a mobile power conversion device for vehicle charging that connects a slow charger capable of supplying only AC power and a vehicle capable of only DC charging with a bidirectional charging interface and provides smooth vehicle charging through AC-DC power conversion.

Another embodiment of the present disclosure aims to provide a mobile power conversion device for vehicle charging that reduces weight and increases electric mileage and reduces cost by omitting an OBC inside a vehicle and provides a smooth AC charging function between a slow charger and a vehicle not equipped with an OBC.

An embodiment of the present disclosure provides a mobile power conversion device for electric vehicle charging, including: a first charging interface electrically connected to an external AC charger on one side; a second charging interface electrically connected to a vehicle without an external on-board charger (OBC) on the other side; a power supply such as a switching mode power supply (SMPS) configured to supply power to the inside of the device; an AC/DC converter configured to convert AC power input from the AC charger into DC power chargeable to a high-voltage battery of the vehicle; and a controller configured to perform vehicle charging control supplying the DC power converted by the AC/DC converter to the vehicle.

The first charging interface may include an inlet plug connected to a charging connector of the AC charger to connect charging communication; a proximity detection (PD) module configured to detect the charging connector of the AC charger connected to the inlet plug; and a control pilot (CP) input module configured to perform pulse width modulation (PWM) based low-level communication with the AC charger when the charging communication is connected.

The second charging interface may include a cable connector connected to a charging plug of the vehicle to connect charging communication; a power line communication (PLC) modem configured to perform high-level communication with the vehicle; and a CP output module required for high-level communication of the PLC modem.

The PLC modem may be configured to support high-level communication with the vehicle based on electric vehicle charging international standard DIN 70121 or ISO 15118.

The power supply may be configured to supply power when a power switch Q3 for power activation inside the device is operated, and may include a regulator configured to maintain the power at a constant voltage required for operation of components inside the device.

The power switch Q3 may be configured as a push-pull switch and may be operated ON/OFF by a user.

The AC/DC converter may be connected to an inlet plug of the first charging interface through an AC line at an input terminal, and may be connected to a cable connector of the second charging interface through a DC line at an output terminal.

The AC line may include an L1 line and an N line and uses these to input AC power to the AC/DC converter, and the DC line may include a DC+ line and a DC− line and uses these to output DC power converted from the AC/DC converter.

A first relay Q1 and a second relay Q2 may be respectively installed on the DC+ line and the DC− line of the DC line to transmit or block the DC power to the vehicle.

The controller may include performs vehicle charging control based on status information collected from the outside or inside the device, monitor the status information or control results, and output them through a display portion.

The controller may include a ready lamp indicating a power activation status inside the device; a charge lamp indicating ON/OFF of vehicle charging; and a fault lamp indicating occurrence of an abnormal situation inside the device.

Another embodiment of the present disclosure provides a control method of a mobile power conversion device for electric vehicle charging, including: a step in which an external AC charger and a vehicle without an on-board charger (OBC) are respectively connected to a first charging interface and a second charging interface, and power inside the device is activated by turning on a power switch Q3; a step of checking whether an electrical connection status of the first charging interface and the second charging interface is normal for vehicle charging preparation; a step of operating both a first relay Q1 and a second relay Q2 installed on an AC/DC converter and a DC line to ON if the electrical connection status is normal; and a step of performing vehicle charging control by converting AC power input from the AC charger into DC power through the AC/DC converter and supplying it to the vehicle.

The step of checking whether the electrical connection status is normal may include a step of collecting a CP PWM signal of the AC charger through the first charging interface, and determining whether a connection is normal by comparing a CP state and a PD voltage with respective reference values; a step of determining an abnormal connection state if at least one of the CP voltage and the PD voltage does not satisfy a corresponding reference value, and indicating occurrence of an abnormal situation inside the device by turning ON a fault lamp of a display portion; or a step of operating a second switch SW2 positioned on the first charging interface side to ON if both the CP voltage and the PD voltage satisfy the corresponding reference values.

The step of checking whether the electrical connection status is normal may include a step in which CP ±12V PWM is generated from the AC charger side and a first switch SW1 positioned on the second charging interface side is turned on; and a step of turning ON a PLC modem and connecting high-level communication with the vehicle through the second charging interface.

The step of performing vehicle charging control may include a step of indicating a vehicle charging state by turning ON a charge lamp of a display portion.

The control method of the mobile power conversion device may further include, after the step of performing vehicle charging control, a step of inputting one of charging termination by the AC charger, charging termination by the vehicle, and internal fault occurrence during the vehicle charging control; and a step of terminating vehicle charging by turning OFF both the AC/DC converter and the first relay Q1 and the second relay Q2.

The step of terminating vehicle charging may include a step of indicating a vehicle charging termination state by turning OFF the charge lamp of the display portion, and when the internal fault occurs, the fault lamp of the display portion may be turned on to further indicate the internal fault status.

### BRIEF DESCRIPTION OF THE DRAWINGS

FIG. 1 illustrates a schematic view of a mobile power conversion device for electric vehicle charging according to an embodiment of the present disclosure.

FIG. 2 schematically illustrates components of a mobile power conversion device for electric vehicle charging according to an embodiment of the present disclosure.

FIG. 3 and FIG. 4 schematically illustrate flowcharts of a control method of a mobile power conversion device for electric vehicle charging according to an embodiment of the present disclosure.

FIG. 5 illustrates a conventional AC slow charging system for electric vehicle charging.

### DETAILED DESCRIPTION OF ILLUSTRATIVE EMBODIMENTS

The present disclosure will be described more fully hereinafter with reference to the accompanying drawings, in which embodiments of the disclosure are shown.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. The terms “include” and/or “including” and “comprise” and/or “comprising” specify the presence of the mentioned characteristics, integers, steps, operations, constituent elements, and/or components when used in the present specification, but it will also be understood that this does not exclude the presence or addition of one or more of other characteristics, integers, steps, operations, constituent elements, components, and/or groups thereof. As used herein, the term “and/or” includes any one or all combinations of the associated and listed items.

Throughout the specification, terms such as first, second, ‘A’, ‘B’, (a), (b), and the like will be used only to describe various constituent elements, and are not to be interpreted as limiting these constituent elements. These terms are only used to distinguish one element from another element, and the feature or order of the element is not limited by these terms.

Throughout the specification, it should be understood that, when it is described that an element is “coupled” or “connected” to another element, the element may be “directly coupled” or “directly connected” to the another element, or may be “coupled” or “connected” to the other element through a third element. In contrast, it should be understood that, when it is described that an element is “directly coupled” or “directly connected” to another element, no element is present between the element and the other element.

Throughout the specification, the terms used herein are used only to describe specific embodiments or examples, and are not intended to limit the present disclosure. Singular forms are intended to include plural forms unless the context clearly indicates otherwise.

In addition, it is understood that one or more of the methods below or the aspects thereof may be executed by at least one or more controllers. The term “controller” may refer to a hardware device including a memory and a processor. The memory is configured to store program commands, and the processor is specially programmed so as to execute program commands to perform one or more processes described in more detail below. The controller may control operations of units, modules, components, devices, or similar matters thereof as described herein. Further, it is understood that the following methods may be executed by a device including a controller together with one or more other components as recognized by those skilled in the art.

Hereinafter, a mobile power conversion device for electric vehicle charging and a control method thereof according to an embodiment of the present disclosure will be described in detail with reference to the accompanying drawings.

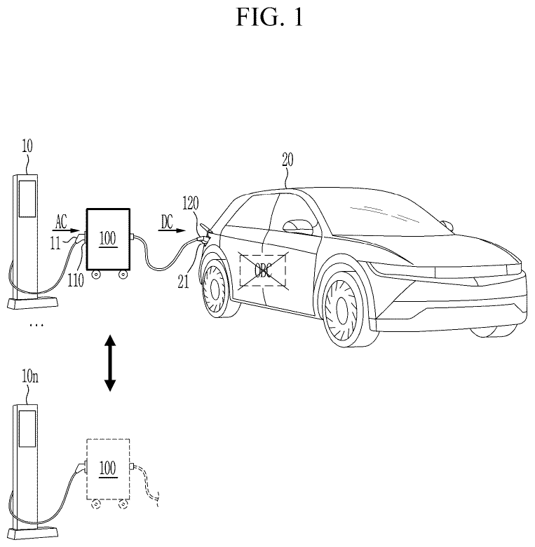

FIG. 1 illustrates a schematic view of a mobile power conversion device for electric vehicle charging according to an embodiment of the present disclosure.

Referring to FIG. 1 when an on-board charger (OBC) is not installed in a vehicle 20, AC charging using an AC charger 10 is not possible, and a user must always look for a DC fast charger, which is inconvenient.

Accordingly, the mobile power conversion device 100 for charging an electric vehicle according to an embodiment of the present invention is connected between an AC charger 10 capable of supplying only AC power to a vehicle and the vehicle 20 (that is, an electric vehicle capable of only DC charging) without an OBC to provide a smooth vehicle charging function through AC-DC power conversion.

Another objective of the present disclosure is to provide a mobile power conversion device for electric vehicle charging that improves customer satisfaction by omitting an OBC inside the vehicle, thereby increasing electric mileage due to weight reduction and reducing vehicle price, and by providing a smooth charging function between the AC charger 10 and the vehicle 20.

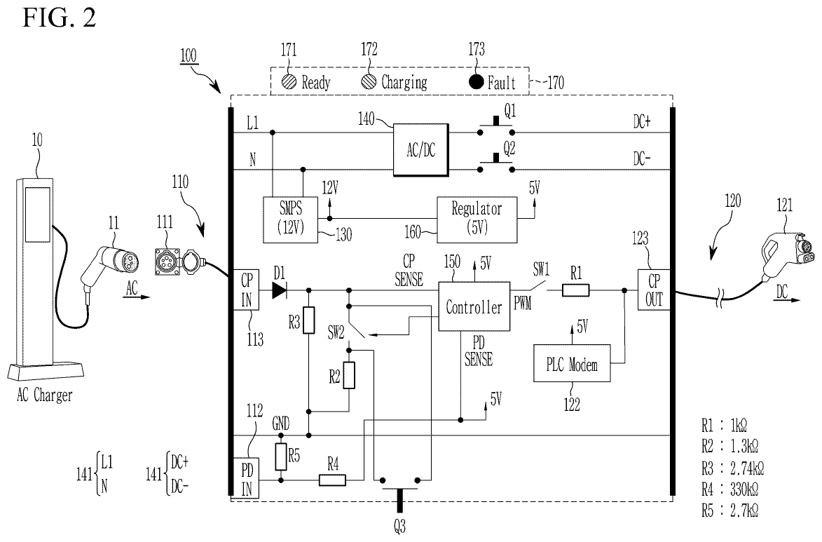

Meanwhile, FIG. 2 schematically illustrates components of a mobile power conversion device for electric vehicle charging according to an embodiment of the present disclosure.

Referring to FIG. 2, the mobile power conversion device 100 for electric vehicle charging according to an embodiment of the present disclosure includes a bidirectional charging interface (110, 120) electrically connecting the AC charger 10 provided on one side and the vehicle 20 provided on the other side, a switching mode power Supply (SMPS) 130 for supplying power to the inside of the device, an AC/DC converter 140 for converting AC power input from the AC charger 10 into DC power that may be charged to a high-voltage battery of the vehicle 20, and a controller 150 for performing vehicle charging control that supplies the DC power converted by the AC/DC converter 140 to the vehicle 20.

The AC charger 10 is external charging infrastructure, that is, electric vehicle supply equipment (EVSE), and it may charge the vehicle 20 by supplying only AC power.

The vehicle 20 may be an electric vehicle (EV) or a plugin hybrid electric vehicle (PHEV) that may be charged only with DC power without an on-board charger (OBC).

The mobile power conversion device 100 may be implemented to be movable by a user by mounting the above-described components 110 to 150 and various circuit components and switching elements, which will be described later, inside the device and by providing external moving members such as wheels.

The mobile power conversion device 100 acts as a kind of intermediary that supports vehicle charging between the AC charger 10 that supplies AC power and the vehicle 20 that is charged with DC power, by moving according to a user's needs.

The bidirectional charging interfaces 110 and 120 include a first charging interface 110 positioned on one side and electrically connected to the external AC charger 10, and a second charging interface 120 positioned on the other side and electrically connected to the external vehicle 20.

The first charging interface 110 includes an inlet plug 111 that is connected to a charging connector 11 of the AC charger 10 to connect charging communication, a proximity detection (PD) module 112 that detects the charging connector 11 of the AC charger 10 connected (coupled) to the inlet plug 111, and a control pilot (CP) input module 113 that performs low level communication based on pulse width modulation (PWM) with the AC charger 10 when the charging communication is connected.

For example, the inlet plug 111 has an inlet configuration of a corresponding type (for example, Type 1) according to the type of charging connector 11 of the AC charger 10 (for example, AC Type 1). That is, the inlet plug 111 may be provided in various compatible types of inlet configurations according to the type of charging connector 11 of the AC charger 10.

The PD module 112 detects whether the inlet plug 111 and the charging connector 11 of the AC charger 10 are connected, and transmits a PD signal, corresponding to the connection detection, to the controller 150.

The CP input module 113 receives a CP signal from the AC charger 10 and transmits it to the controller 150.

The second charging interface 120 includes a cable connector 121 that is connected to a charging plug of the vehicle 20 to connect charging communication, a power line communication (PLC) modem 122 for performing high-level communication with the vehicle 20, and a CP output module 123 necessary for the high-level communication of the PLC modem 122. That is, the second charging interface 120 enables high-level communication-based AC/DC charging with the vehicle 20.

The PLC modem 122 may support high-level communication with the vehicle 20 based on the international standard for electric vehicle charging, DIN 70121 or ISO 15118.

The SMPS 130 supplies power when the power switch Q3 for power activation within the device is actuated. In this case, the SMPS 130 includes a regulator 160 that maintains the power at a constant voltage required for the operation of components within the device.

The power switch Q3 may be configured as a push-pull switch and is operated ON/OFF by a user.

In the above description, the first charging interface 110 and the second charging interface 120 have been described as being configured with the inlet plug 111 and the cable connector 121, respectively. However, the embodiment of the present disclosure is not limited thereto, and the first charging interface 110 and the second charging interface 120 may be configured with either a corresponding inlet plug or a cable connector depending on the cable connection structure (connector/inlet) of the AC charger 10 and the vehicle 20.

The AC/DC converter 140 is connected to the inlet plug 111 of the first charging interface 110 via an AC line 141 at an input terminal, and is connected to the cable connector 121 of the second charging interface 120 via a DC line 142 at an output terminal.

The AC line 141 includes an L1 line and an N line, and uses them to input AC power to the AC/DC converter 140.

The DC line 142 includes a DC+ line and a DC− line, and uses them to output DC power converted by the AC/DC converter 140.

A first relay Q1 and a second relay Q2 are respectively installed on the DC+ line and the DC− line of the DC line 142 to transmit (On) or block (Off) the output DC power to the vehicle 20.

The first relay Q1 and the second relay Q2 may operate ON/OFF through switch control. For example, the first relay Q1 and the second relay Q2 can be turned ON and operated in a closed state during vehicle charging control, and can be turned OFF and operated in an open state when not charging (for example, before charging initiation/after charging completion).

The AC/DC converter 140 may convert the input AC power into high-voltage DC power and output it.

The controller 150 controls the overall operation of the mobile power conversion device 100, and includes at least one program and data for that control. That is, the controller 150 is configured of a combination of hardware (HW) and software (SW) for vehicle charging control.

The controller 150 may perform vehicle charging control according to state information collected externally or within the device, and may monitor the state information or control results and output them through a display portion 170. For example, the display portion 170 includes a ready lamp 171 indicating the power activation status within the device, a charge lamp 172 indicating whether charging is ON/OFF, and a fault lamp 173 indicating the occurrence of an abnormal situation within the device.

The controller 150 may be implemented as one or more processors operating according to a set program, and the set program may be programmed to perform each step in a control method of a mobile power conversion device for electric vehicle charging according to embodiments of the present disclosure.

The control method of the mobile power conversion device for electric vehicle charging will be described in more detail with reference to the drawings below.

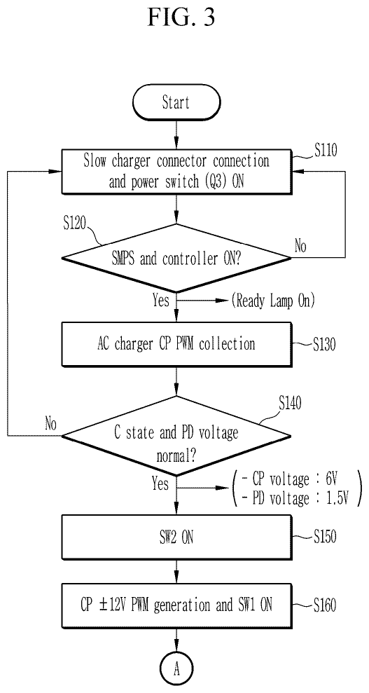

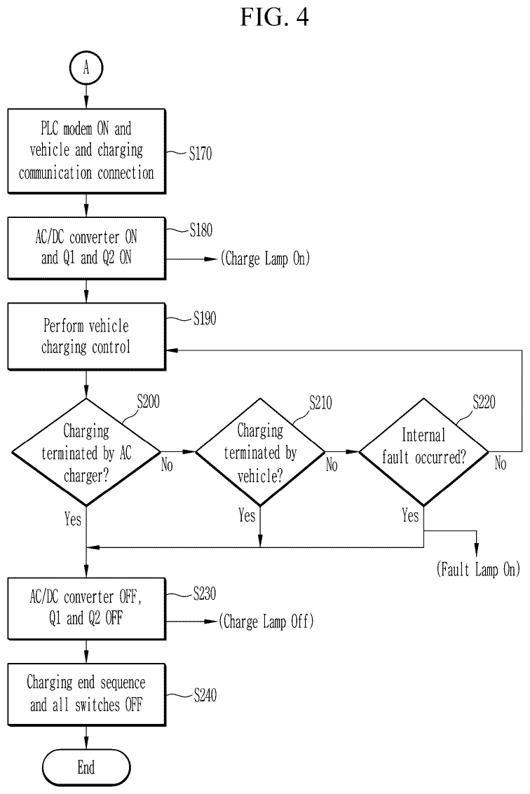

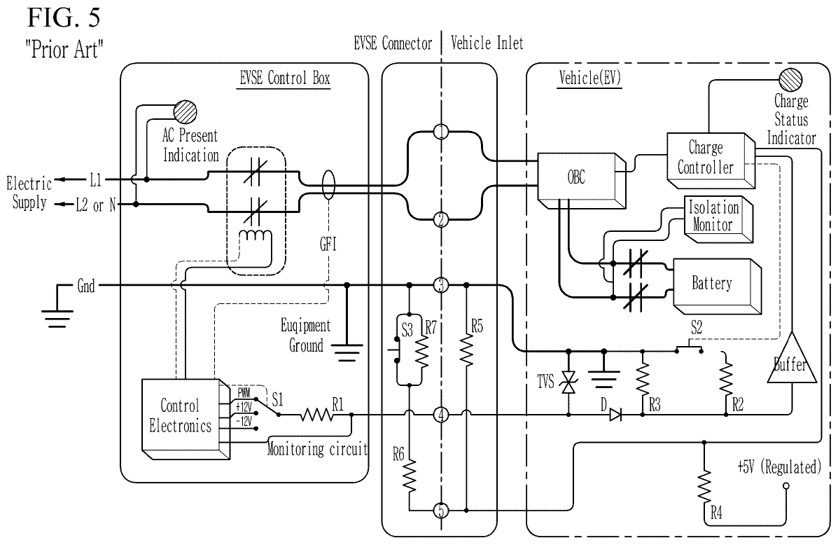

FIG. 3 and FIG. 4 schematically illustrate flowcharts of a control method of a mobile power conversion device for electric vehicle charging according to an embodiment of the present disclosure.

Referring to FIG. 3 and FIG. 4, the control method of the mobile power conversion device for electric vehicle charging according to the embodiment of the present disclosure includes a step (S110) in which the power switch Q3 is turned on to connect the charging connector 11 of the AC charger 10 to the first charging interface 110 of the mobile power conversion device 100 by the user and to activate the power inside the device. In this case, the charging plug of the vehicle 20 may be connected to the second charging interface 120.

The mobile power conversion device 100 determines whether the power supply (SMPS) 130 and the controller 150 within the device are operating (ON) (S120).

For example, if the power supply 130 is activated (ON) by the connection of the charging connector 11 of the AC charger 10 and the ON state of the power switch Q3, supplying power to the interior of the device, and the controller 150 is activated (ON) by that power (S120; Yes), the mobile power conversion device 100 prepares for vehicle charging. In this case, the controller 150 may turn on the ready lamp 171 of the display portion 170 to indicate the power activation status inside the device (Ready Lamp On).

That is, the controller 150 is activated by the ON operation of the power switch Q3 when the AC charger 10 and the vehicle 20 are respectively connected to the first charging interface 110 and the second charging interface 120 by the user. In addition, the controller 150 checks whether the electrical (charging communication) connection status of the bidirectional charging interfaces 110 and 120 to be described later is normal in preparation for vehicle charging.

Hereinafter, the control method (flow) of the mobile power conversion device 100 may be described with the controller 150 as the subject, which controls the overall operation of the device.

The controller 150 collects a CP PWM signal of the AC charger 10 through the first charging interface 110 (S130), and determines whether a normal connection is established by comparing the CP state and PD voltage with respective reference values (S140). The reference values may be set based on international standards for electric vehicle charging.

For example, the controller 150 compares whether the CP voltage satisfies a first reference value (for example, 6V) and the PD voltage satisfies a second reference value (for example, 1.5V), and if at least one does not satisfy the corresponding reference value (S140; No), it determines it as an abnormal connection state and returns to step S110. In this case, the controller 150 turns on the fault lamp 173 of the display portion 170 to indicate an abnormal situation within the device (Fault Lamp On). Therefore, it prompts the user to check and/or reconnect the connection status or to confirm that the usage complies with the normal (for example. international standards for electric vehicle charging) specifications.

On the other hand, if the CP voltage satisfies the first reference value and the PD voltage satisfies the second reference value (S140; Yes), the controller 150 operates a second switch SW2 positioned on the first charging interface 110 side to an ON state (S150). Therefore, normal charging communication with the AC charger 10 side is established.

Meanwhile, when CP ±12V PWM is generated from the AC charger 10 side and the second switch SW1 positioned on the second charging interface 120 side is operated to an ON state (S160), the controller 150 operates the PLC modem 122 (ON) and connects high-level communication with the vehicle 20 through the second charging interface 120 (S170). In this case, the controller 150 may connect high-level communication based on DIN 70121 or ISO 15118 with the vehicle 20 through the PLC modem 122. That is, the controller 150 connects mutual charging communication between the AC charger 10 capable of supplying only AC power and the vehicle 20 capable of charging only DC power, thereby enabling vehicle charging in accordance with international standards for electric vehicle charging (for example, ISO 15118-2). Through this, the controller 150 may transmit at least one charging information, such as the charging capacity, state of charge (SoC), target charging amount, and charging time of the high-voltage battery, between the vehicle 20 and the AC charger 10.

The controller 150 that has completed the vehicle charging preparations as described above initiates the vehicle charging control to be described later.

The controller 150 operates both the AC/DC converter 140 and the first relay Q1 and the second relay Q2 installed in the DC line 142 to On (S180). In this case, actual vehicle charging is initiated, and the controller 150 may turn on the charge lamp 172 of the display portion 170 to indicate the vehicle charging status (Charge Lamp On).

The controller 150 performs vehicle charging control to convert the AC power input from the AC charger 10 into DC power through the AC/DC converter 140 and supply it to the vehicle 20 (S190).

The controller 150 performs vehicle charging control for a set target charging amount and/or charging time, and monitors whether charging by the external AC charger 10 is terminated (S200), whether charging by the vehicle 20 is terminated (S210), and whether an internal fault occurs (S220). For example, the termination of charging by the AC charger 10 and the termination of charging by the vehicle 20 may be input by the user's operation of the corresponding device. The occurrence of the internal fault may occur when an overvoltage/overcurrent, circuit/line short circuit, or the like within the device due to self-diagnosis is recognized.

When one of charging termination by the external AC charger 10, charging termination by the vehicle 20, and internal fault occurrence is input during vehicle charging control (S210 or S220 or S230; Yes), the controller 150 turns off both the AC/DC converter 140 and the first relay Q1 and the second relay Q2 to terminate vehicle charging (S240). In this case, the controller 150 turns off the charge lamp 172 of the display portion 170 to indicate the vehicle charging termination status (Charge Lamp Off). However, when the internal fault occurrence is recognized (S230; Yes), the fault lamp 173 may be turned on to further indicate the internal fault status (Fault Lamp On).

Thereafter, the controller 150 may terminate vehicle charging by turning off all switches SW2 and SW1 positioned at the first charging interface 110 and the second charging interface 120 sides according to the charging termination sequence (S250).

Meanwhile, when the controller 150 completes the vehicle charging control for the set target charging amount and/or charging time without any singularity during the vehicle charging control (S210 and S220 and S230; No), it normally performs steps S230 and S240 and then terminates the vehicle charging.

As described above, according to the embodiments of the present disclosure, a mobile power conversion device is provided that connects an AC charger capable of supplying only AC power and a vehicle without an OBC through a bidirectional communication interface and provides a smooth vehicle charging function through AC-DC power conversion, thereby supporting a vehicle capable of only DC charging to use an AC charger anywhere.

In addition, there is an effect of increasing driving distance (electric efficiency) by reducing cost and vehicle weight through the elimination of the OBC and related high-voltage cables installed in conventional vehicles.

In addition, there is an effect of supporting charging communication based on high-level communication between vehicles without OBC through a mobile power conversion device. Accordingly, it is possible to transmit and receive data required for various electric vehicle charging-related application services (for example, charging start and end, communication channel setting, billing and payment, authentication and security, charging control and scheduling, vehicle added services, and the like) based on high-level communication.

The above-described methods and apparatuses are not only realized by the embodiment of the present disclosure, but, on the contrary, are intended to be realized by a program for realizing functions corresponding to the configuration of the embodiment of the present disclosure or a non-transitory recording medium for recording the program.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A mobile power conversion device for electric vehicle charging, comprising:
a first charging interface electrically connected to an external alternating current (AC) charger on a first side;
a second charging interface electrically connected to a vehicle without an external on-board charger (OBC) on a second side;
a switching mode power supply (SMPS) configured to supply power to an inside of the mobile power conversion device;
an alternating current/direct current (AC/DC) converter configured to convert AC power input from the AC charger into direct current (DC) power chargeable to a high-voltage battery of the vehicle; and
a controller configured to perform vehicle charging control by supplying the DC power converted by the AC/DC converter to the vehicle.

2. The mobile power conversion device for electric vehicle charging of claim 1, wherein:
the first charging interface includes an inlet plug connected to a charging connector of the AC charger to connect charging communication;
a proximity detection (PD) module configured to detect the charging connector of the AC charger connected to the inlet plug; and
a control pilot (CP) input module configured to perform pulse width modulation (PWM) based low-level communication with the AC charger when the charging communication is connected.

3. The mobile power conversion device for electric vehicle charging of claim 1, wherein:
the second charging interface includes a cable connector connected to a charging plug of the vehicle to connect charging communication;
a power line communication (PLC) modem configured to perform high-level communication with the vehicle; and
a control pilot (CP) output module required for high-level communication of the PLC modem.

4. The mobile power conversion device for electric vehicle charging of claim 3, wherein:
the PLC modem is configured to support high-level communication with the vehicle based on electric vehicle charging international standard DIN 70121 or ISO 15118.

5. The mobile power conversion device for electric vehicle charging of claim 1, wherein:
the SMPS is configured to supply power when a power switch Q3 for power activation inside the mobile power conversion device is operated, and
the SMPS includes a regulator configured to maintain the power at a constant voltage required for operation of components inside the mobile power conversion device.

6. The mobile power conversion device for electric vehicle charging of claim 5, wherein:
the power switch Q3 is configured as a push-pull switch and is operated ON/OFF by a user.

7. The mobile power conversion device for electric vehicle charging of claim 1, wherein the AC/DC converter is connected to:
an inlet plug of the first charging interface through an AC line at an input terminal, and
a cable connector of the second charging interface through a DC line at an output terminal.

8. The mobile power conversion device for electric vehicle charging of claim 7, wherein:
the AC line includes an L1 line and an N line and uses the L1 line and the N line to input AC power to the AC/DC converter, and
the DC line includes a DC+ line and a DC− line and uses the DC+ line and the DC− line to output DC power converted from the AC/DC converter.

9. The mobile power conversion device for electric vehicle charging of claim 8, wherein:
a first relay Q1 and a second relay Q2 are respectively installed on the DC+ line and the DC− line of the DC line to transmit or block the DC power to the vehicle.

10. The mobile power conversion device for electric vehicle charging of claim 1, wherein the controller is further configured to:
perform the vehicle charging control based on status information collected from outside or inside the mobile power conversion device;
monitor the status information or control results; and
output the status information or the control results through a display portion.

11. The mobile power conversion device for electric vehicle charging of claim 10, wherein the controller includes:
a ready lamp indicating a power activation status inside the mobile power conversion device;
a charge lamp indicating ON/OFF of vehicle charging; and
a fault lamp indicating occurrence of an abnormal situation inside the mobile power conversion device.

12. A control method of a mobile power conversion device for electric vehicle charging, the control method comprising:
connecting an external alternating current (AC) charger and a vehicle without an on-board charger (OBC), respectively, to a first charging interface and a second charging interface;
activating power inside the mobile power conversion device by turning on a power switch Q3;
checking whether an electrical connection status of the first charging interface and the second charging interface is normal for vehicle charging preparation;
operating both a first relay Q1 and a second relay Q2 installed on an alternating current/direct current (AC/DC) converter and a direct current (DC) line to ON when the electrical connection status is normal; and
performing vehicle charging control by converting AC power input from the AC charger into DC power through the AC/DC converter and supplying the DC power to the vehicle.

13. The control method of the mobile power conversion device of claim 12, wherein checking whether the electrical connection status is normal includes:
collecting a control pilot (CP) pulse width modulation (PWM) signal of the AC charger through the first charging interface;
determining whether a connection is normal by comparing a CP state and a proximity detection (PD) voltage with respective reference values;
determining an abnormal connection state when at least one of the CP state and the PD voltage does not satisfy a corresponding reference value;
indicating, in response to determining the abnormal connection state, occurrence of an abnormal situation inside the device by turning ON a fault lamp of a display portion; and
operating a second switch SW2 positioned on a first charging interface side to ON when both the CP state and the PD voltage satisfy the corresponding reference values.

14. The control method of the mobile power conversion device of claim 12, wherein checking whether the electrical connection status is normal includes:
generating a control pilot (CP) ±12V pulse width modulation (PWM) signal from an AC charger side;
turning on a first switch SW1 positioned on a second charging interface side;
turning ON a power line communication (PLC) modem; and
connecting high-level communication with the vehicle through the second charging interface.

15. The control method of the mobile power conversion device of claim 12, wherein performing the vehicle charging control includes indicating a vehicle charging state by turning ON a charge lamp of a display portion.

16. The control method of the mobile power conversion device of claim 12, further comprising:
after performing vehicle charging control, inputting one of charging termination by the AC charger, charging termination by the vehicle, and occurrence of an internal fault during the vehicle charging control; and
terminating vehicle charging by turning OFF both the AC/DC converter and the first relay Q1 and the second relay Q2.

17. The control method of the mobile power conversion device of claim 16, wherein:
terminating the vehicle charging includes indicating a vehicle charging termination state by turning OFF a charge lamp of a display portion, and
when the internal fault occurs, a fault lamp of the display portion is turned on to further indicate an internal fault status.

18. A non-transitory computer readable medium storing instructions which, when executed by one or more processors of a controller of a mobile power conversion device, cause the one or more processors to:
determine that an external alternating current (AC) charger is connected to a first charging interface of the mobile power conversion device;
determine that a vehicle without an on-board charger (OBC) is connected to a second charging interface of the mobile power conversion device;
activate power inside the mobile power conversion device by turning on a power switch Q3;
check whether an electrical connection status of the first charging interface and the second charging interface is normal for vehicle charging preparation;
operate a first relay Q1 and a second relay Q2 installed on an alternating current/direct current (AC/DC) converter and a direct current (DC) line to ON when the electrical connection status is normal; and
perform vehicle charging control by converting AC power input from the AC charger into DC power through the AC/DC converter and supplying the DC power to the vehicle.

19. The non-transitory computer readable medium of claim 18, wherein, to check whether the electrical connection status is normal, the execution of the instructions by the one or more processors further causes the one or more processors to:
collect a control pilot (CP) pulse width modulation (PWM) signal of the AC charger through the first charging interface;
determine whether a connection is normal by comparing a CP state and a proximity detection (PD) voltage with respective reference values;
determine an abnormal connection state when at least one of the CP state and the PD voltage does not satisfy a corresponding reference value;
indicate, in response to determining the abnormal connection state, occurrence of an abnormal situation inside the mobile power conversion device by turning ON a fault lamp of a display portion; and
operate a second switch SW2 positioned on a first charging interface side to ON when both the CP state and the PD voltage satisfy the corresponding reference values.

20. The non-transitory computer readable medium of claim 18, wherein, to check whether the electrical connection status is normal, the execution of the instructions by the one or more processors further causes the one or more processors to:
generate a control pilot (CP) ±12V pulse width modulation (PWM) signal from an AC charger side;
turn on a first switch SW1 positioned on a second charging interface side;
turn ON a power line communication (PLC) modem; and
connect high-level communication with the vehicle through the second charging interface.
